(19) United States
(12) Patent Application Publication
(10) Pub. No.: US 2008/0012685 A1
(43) Pub. Date: Jan. 17, 2008

(54) Scalable method for access control

(76) Inventors: Ulrich Friedrich, Ellhofen (DE); Michael Pangels, Ludwigsburg (DE)

Correspondence Address: MG-IP Law, PLLC, P.O. BOX 1364, FAIRFAX, VA, 22038-1364, US

(21) Appl. No.: 11/822,308

(22) Filed: Jul. 5, 2007

Related U.S. Application Data
(60) Provisional application No. 60/819,387, filed on Jul. 10, 2006.

(30) Foreign Application Priority Data
Jul. 5, 2006 (DE) DE 102006032129

(51) Int. Cl. G05B 19/00

(52) U.S. Cl. 340/5.25; 340/5.61; 340/10.51; 711/163; 711/170

(57) ABSTRACT

A method for specifying access authorization to at least one memory area of a transponder is provided, in which the memory area is assigned access control information, whereby the access control information comprises at least one configurable master access control information, and write access to the memory area is released at least by a first configuration of the master access control information and write access to the memory area is blocked by a second configuration of the master access control information, whereby in the method the access control information is stored further in the transponder, the access control information is assigned at least one first settable sub-access control information, and the information is scaled by the assignment of the first sub-access control information to the master access control information, so that access authorization specified by the configuration of the master access control information is adapted to at least one additional requirement. The invention relates further to scalable transponders and an RFID system comprising a scalable transponder.

This nonprovisional application claims priority to German Patent Application No. DE 102006032129, which was filed in Germany on Jul. 5, 2006, and to U.S. Provisional Application No. 60/819,387, which was filed on Jul. 10, 2006, and which are both herein incorporated by reference.

### BACKGROUND OF THE INVENTION

1. Field of the Invention

The present invention relates to a method for access control to at least one memory area of a transponder, particularly a passive and/or backscatter-based transponder, in which the memory area is assigned access control information that specifies access authorization to the memory area. The invention relates further to a transponder in a radio frequency identification (RFID) system and to an RFID system.

2. Description of the Background Art

Access control methods are used, for example, in contactless identification systems or so-called radio frequency identification (RFID) systems. An access control method is described, for example, in the German patent publication DE 10 2006 002 516 A1, which corresponds to U.S. Provisional application No. 60/838,889, and which is incorporated herein by reference. This type of system typically has a base station or a reader or a reader unit and a plurality of transponders or remote sensors, which are located simultaneously in the response range of the base station. The transponders or their transmitting and receiving devices typically do not have an active transmitter for data transmission to the base station. Such inactive systems are called passive systems, when they do not have their own power supply, and semipassive systems, when they have their own power supply. Passive transponders draw the energy necessary for their supply from the electromagnetic field emitted by the base station.

So-called backscatter coupling is employed, as a rule, for data transmission from a transponder to a base station with UHF or microwaves in the far field of the base station. To that end, the base station emits electromagnetic carrier waves, which are modulated and reflected by the transmitting and receiving device of the transponder by a modulation method in accordance with the data to be transmitted to the base station. The typical modulation methods for this are amplitude modulation, phase modulation, and amplitude shift keying (ASK) subcarrier modulation, in which the frequency or the phase position of the subcarrier is modified.

An access control method for transponders is described in the draft standard ISO/IEC_CD 18000-6C of 07 Jan. 2005 (see especially ISO/IEC_CD 18000-6C, Chapter 6.3.2, pages 27-60). The transponder in this case is first selected in a selection or arbitration process from a number of transponders. The described selection process is a stochastic process in the form of a slotted ALOHA protocol. Selection methods of this kind are described in detail, for example, in the handbook by Klaus Finkenzeller, RFID-Handbuch [RFID Handbook], 3^{rd} ed., HANSER, 2002 (see especially Chapter 7.2, Multiple Access Methods—Anticollision, pages 203 to 216).

For access, a reader unit typically transmits a so-called query command. The transponder responds to this query by transmitting a random number. The transponder is singled out by sending an acknowledgement (“acknowledge”). The singled-out transponder transmits protocol control bits (PC) and an identification in the form of a so-called electronic product code (EPC) to the reader unit. The protocol control bits contain information on a physical layer of the transmission path. The identification or the electronic product code EPC represents, inter alia, a product tagged with the transponder. The assignment of an EPC to the tagged product is standardized, so that the product can be inferred from the EPC information. Furthermore, the EPC can be used by the reader unit as a pointer to other information, for example, to a password assigned to the EPC. The password can be used to block memory areas in the transponder for write accesses.

After the transmission of the PC and EPC by the transponder, read and/or write access to memory areas within the transponder by the reader unit is possible, unless the specific areas are blocked or locked for write access. Write access is specified, for example, by lock bits. In so doing, write access to the entire memory area is typically specified by the lock bits. Further, read access to passwords can also be barred. Despite possible read blocking of passwords, there is some security risk that unauthorized persons have access to possibly private memory contents.

RFID is employed in a multitude of different applications. This can refer both to closed data management systems, i.e., systems in which the number and/or the type of data are set in the front end, and also to open data management systems, i.e., systems in which the data are constantly expanded and/or varied.

Particularly when a transponder or tag is to be used in an open data management system for a lifetime of a product tagged by the transponder, for example, for identifying a product, it is often desirable that read access to at least certain information, stored in the transponder is not to be open to all parties. This information includes, for example, a manufacturing date, a current owner, etc. Other data, however, are to be made available by the transponder to a plurality of different reader units or base stations. If access is possible in this case, for example, only by means of passwords, an exchange of passwords is necessary for this. An exchange of passwords, however, is possible in many cases only at high cost, particularly in open systems.

For example, when the transponder is used in so-called chip cards, personal data may be stored as memory contents. In this regard, it is desirable to regulate access to these data, for example, so that upon entry into a store it cannot be determined automatically by reading the memory contents whether the particular customer still has funds on the chip card.

It is conceivable, furthermore, that a potential attacker attempts to read out data from a transponder in order to thus duplicate the transponder, for example, to place counterfeit goods in circulation or to commit sabotage. For this reason as well, it is desirable in many cases that, apart from passwords stored in the transponder, other data are also not freely accessible to all persons.

### SUMMARY OF THE INVENTION

It is therefore an object of the present invention to provide a method for access control that makes possible powerful and flexible access control to memory areas of the transponder and efficient memory utilization. The object of the invention, furthermore, is to create a transponder with access control, adaptable to different requirements, and an RFID system comprising a transponder.

The object is achieved in particular by a method for access control to at least one memory area of a transponder, particularly a passive and/or backscatter-based transponder, in which the memory area is assigned access control information. The access control information thereby comprises at least one configurable master access control information, whereby write access to the memory area is released at least by a first configuration of the master access control information and write access to the memory area is blocked by a second configuration of the master access control information. The access control information is stored in the transponder. According to the invention, the master access control information is assigned at least one first settable sub-access control information and the access control information is scaled by the first sub-access control information, so that access authorization specified by the configuration of the master access control information is adapted to at least one additional requirement.

It is possible to roughly set access authorization, particularly write authorization, by means of master access control information. For this purpose, in an advantageous embodiment of the invention, the write access is specified by the lock bits known from the aforementioned draft standard. The access to the memory area according to the invention may be set further individually by the sub-access control information, special requirements for a specific transponder being taken into account. At the same time, a uniform structure is created, which makes it possible to design the transponder and/or access to the transponder consistently within broad ranges.

In an embodiment of the invention, access authorization for read access to the memory area is specified by the first sub-access control information. In the aforementioned draft standard ISO/IEC_CD 18000-6C, apart from read protection for the password or passwords, no restriction is being planned so far for read access to transponders. A potential attacker, however, can read out data in the transponder due to the read access and duplicate and/or manipulate the transponder perhaps for his own purposes in order to thus fake, for example, the authenticity of a product. The invention therefore provides that read access can also be restricted if required. This takes advantage of the situation that as a rule, during release of write access, also no restriction for the read access is desired. Conversely, however, despite a blocked write access, read access can be released completely or with conditions.

In an aspect of the invention, the first sub-access control information specifies access authorization for read and/or write access to the memory area depending on at least one password. In an embodiment, it is possible to specify, for example, that read access is protected by a first password, whereas write access is protected by a second password. In this way, different users can be granted different access by appropriate distribution of the passwords to read units.

In an embodiment of the invention, the first sub-access control information is overloaded at least in part, whereby a configuration of the sub-access control information can be assigned at least two options for access control and the access authorization is specified at least depending on the master access control information, the first sub-access control information, and a selection parameter. The overloading of the sub-access control information makes it possible to perform several different settings, without the number of sub-access control information having to be increased for this. The selection of a certain option for access control is then specified depending on the master access control information, the first sub-access control information, and a selection parameter.

In an embodiment of the invention, the first sub-access control information comprises at least one sub-bit, preferably at least two sub-bits, by which four bit patterns are formed. A number of possible settings and thereby an intensity of scalability can be determined by the number of bits. The sub-access control information can be overloaded in this case, as described above, to increase the number of settings.

In an aspect of the invention, the master access control information comprises two main bits, whereby a first bit pattern formed from the two main bits releases write access to the memory area, a second bit pattern formed from the two main bits releases write access to the memory area in an “open” or a “secure” state of the transponder, a third bit pattern formed from the two main bits releases write access to the memory area in the “secure” state of the transponder, and a fourth bit pattern formed from the two main bits blocks write access. The “open” or the “secure” state of the transponder is defined by the aforementioned draft standard (see ISO/IEC_CD 18000-6C, Subchapter 6.3.2.4.5 and 6.3.2.4.6).

In an embodiment of the invention, the first bit pattern is “00,” the second bit pattern “01,” the third bit pattern “10,” and the fourth bit pattern “11,” are each in binary notation.

The first sub-access control information can be scaled by at least one lower-ranking second sub-access control information. As a result, the access control can be adapted even better to different requirements, and a consistent structure is retained.

In an aspect of the invention, the second sub-access control information comprises at least one sub-bit, preferably at least two sub-bits, particularly four sub-bits, by which 16 bit patterns are formed.

In an embodiment of the invention, the memory area is divided into at least two memory blocks, whereby access authorization to the memory blocks can be specified individually by the first and/or the second sub-access control information. It is conceivable that a transponder is assigned to a product, for example, a control device for a motor vehicle, which during its origin or transport history up to delivery to the point of sales (POS) is assigned a plurality of users with authorized access. The users with authorized access must thereby store, for example, data from test results or the like in the transponder. Moreover, it is desirable, for example, that the time of a transfer of risk is recorded by every user with authorized access in the transponder by means of a type of time stamp. As a rule, it is desirable thereby that data, which were once stored in the transponder, are not overwritten. It is therefore provided according to the invention that the different users with access authorization each can access one or more memory blocks by means of a password, but read and/or write access for other users without the associated password is blocked.

In an embodiment of the invention, the access control information can be stored at least in part in a shadow memory area, whereby the shadow memory area is divided into sub-memory areas parallel to the memory blocks. In this regard, a non-volatile memory, in which access control information is stored, is designated as the shadow memory area.

In an aspect of the invention, the subdivision into memory blocks and/or into sub-memory areas can be carried out dynamically during an initialization. The shadow memory area and/or the memory area therefore are individually adaptable to specific requirements, whereby no fixed memory area is provided for this. As a result, the memory resources of the transponder can be optimally utilized.

In an aspect of the invention, the access control information is stored in an only one-time programmable memory, particularly in a one-time programmable shadow memory, of the transponder. This process is also called “permalock.” The structure of the access authorization here is established once during the setting up of the transponder. As a result, manipulation of the access control at a later time is preventable. In another embodiment, the cells of the shadow memory are designed at least partially in such a way that they may be programmed only in one direction, for example, can be set to “1.” Deletion, i.e., resetting to “0,” however, is prevented. It is thereby possible to increase but not to reduce the access protection at a later time.

In an embodiment of the invention, a presence of access control information scaled by at least one sub-access control information in the transponder can be indicated to a reader unit. As a result, good integration into a general system is possible.

The object is attained further by means of a transponder, particularly a passive and/or backscatter-based transponder, for an RFID system, comprising at least one transponder and at least one reader unit, with at least one memory area, whereby the memory area is assigned access control information, the access control information comprises at least one configurable master access control information, and write access to the memory area is released at least by a first configuration of the master access control information, and write access to the memory area is blocked by a second configuration of the master access control information, the access control information comprises at least one first sub-access control information and the master access control information is scaled by the first sub-access control information, so that access authorization specified by the configuration of the master access control information is adapted to at least one other requirement.

This type of transponder is configured individually and thus can be adapted to highly different requirements.

Furthermore, the object is attained by an RFID system comprising at least one reader unit and one transponder. Preferably, the system comprises a plurality of reader units and of transponders; in this case, the reader units have different access authorizations.

In a development of the invention, the first sub-access control information is at least partially overloaded, whereby access authorization is specified at least depending on the master access control information, the first sub-access control information, and a selection parameter, and at least one selection parameter is stored in a cross reference list. The cross reference list is made available to the reader unit, for example, via the Internet. Preferably, the cross reference list is defined by consistent rules, for example, within the scope of a standardization.

In a development of the invention, at least one configuration bit, which can be read out by the reader unit, is stored in the transponder, whereby the configuration bit indicates at least one scaling effect, a scaling intensity, and/or a selection parameter. The configuration bit here can be stored, for example, in the date of the transponder.

The object is attained further by a method for specifying access authorization to at least one memory area of particularly a passive and/or backscatter-based transponder and a corresponding transponder in which the memory area is assigned access control information, whereby the access control information comprises at least one configurable master access control information, the master access control information comprises two bits, write access to the memory area is released by a first configuration of a first bit of the master access control information, and write access to the memory area is blocked by a second configuration of the first bit of the master access control information, and permanence of the access control information can be specified by the second bit of the master access control information, the access control information is stored in the transponder, the access control information is assigned at least one settable sub-access control information, and the memory area is divided into at least two memory blocks, whereby access authorization to the memory blocks is specified individually by the sub-access control information. The master bits correspond to lock bits known, for example, from the aforementioned ISO/IEC CD 18000-6C 6.3.2.10.3.5, whereby four bit patterns are formed by the two bits. The first master bit in this case specifies write access to the memory area and the second master bit, also called a “permalock bit”, indicates whether the thus specified access can be changed again. The bit pattern can be overloaded thereby, so that, for example, the bit pattern “01” specifies that writing in the “open” or “secure” state of the transponder is possible, whereby due to the set second bit it is further specified that this memory area cannot be assigned write protection at any time. By means of the bit pattern “10” it is specified, on the contrary, that writing is possible only in the “secure” state of the transponder and this write protection cannot be canceled. A blocking, beyond this, of individual memory blocks occurs according to the invention by respective sub-bits.

An embodiment provides in particular that apart from write authorization, access authorization as well for read access to the memory area is specified by the sub-access control information. In this way, adaptations to security-relevant applications can be realized in a simple manner.

In a further embodiment of the invention, the access control information is stored at least in part in a shadow memory area, whereby the shadow memory area is divided into sub-memory areas parallel to the memory blocks. Here, a non-volatile memory, in which access control information is stored, is designated as the shadow memory area.

In a development of the invention, the subdivision into memory blocks and/or into sub-memory areas is carried out dynamically during an initialization. The shadow memory area and/or the memory area therefore are individually adaptable to specific requirements, whereby no fixed memory area is provided for this. As a result, the memory resources of the transponder can be utilized optimally.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows possible bit patterns of an access control information;

FIG. 2 is a schematic drawing of a memory area divided into memory blocks and an associated shadow memory area;

FIG. 3 is a schematic drawing of a dynamic division of the memory area and the shadow memory area into memory blocks;

FIG. 4 is a schematic drawing of a memory area divided into memory blocks and an associated shadow memory area according to a second exemplary embodiment, and

FIG. 5 is a schematic drawing of a memory area divided into memory blocks and an associated shadow memory area according to a third exemplary embodiment.

### DETAILED DESCRIPTION

An access authorization to a memory area of a transponder is specified by the access control information. According to the invention, access control information comprises a master access control information and at least one first sub-access control information, by which the master access control information is scaled, so that an individual setting of an access authorization can be specified. In an embodiment, the master access control information and the sub-access control information are each formed by a bit pattern, comprising two bits in each case.

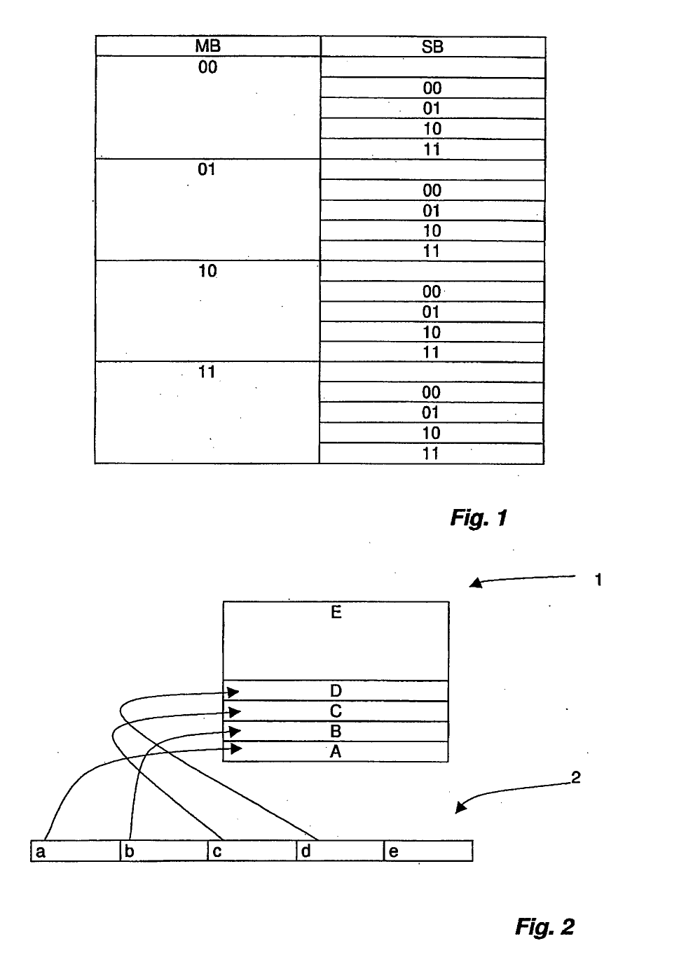

FIG. 1 shows schematically the possible bit patterns with use of two bits in each case, whereby the first column shows the master bits MB, which are scaled by the sub-bits SB shown in the second column.

The master bits MB are, for example, the lock bits known from the aforementioned draft standard (see, for example, ISO/IEC_CD 18000-6C 6.3.2.10.3.5). In an advantageous embodiment, the master bits MB are assigned the following meaning:
00: no write protection;
01: writing is possible only in the “open” or “secure” state of the transponder;
10: writing is possible only in the “secure” state of the transponder, and
11: writing to this memory area is not possible in any transponder state.

In another embodiment (not shown), only a master bit is present, which assumes either the value “0” or the value “1,” whereby, for example, there is no write protection at the value “0” and the memory area is protected at least against writing at the value “1.”

The authorization can be scaled further by means of the sub-bits SB, i.e., can be adapted to specific requirements. The setting options thereby depend, inter alia, on other transponder settings. For compatibility with transponders without scaling capabilities, in an embodiment a pattern or configuration of the sub-bits is assigned the “unscaled” option, for example, the pattern “00”.

In a first exemplary embodiment, a transponder of this type is set in such a way that the transponder is assigned only one identifier (ID). Possible settings for access to the memory area are given in the following table; the bit patterns of the master bits are shown in the first column and the bit patterns of the sub-bits in the second column.

| | | |
|---|---|---|
| 00 | 00 | No restriction during reading or writing |
| | 01 | Still unassigned or reserved for later functions |
| | 10 | Still unassigned or reserved for later functions |
| | 11 | Still unassigned or reserved for later functions |
| 01 | 00 | Writing and reading possible only in the “open” or “secure” |
| | | state |
| | 01 | Writing and reading possible only in the “open” or “secure” |
| | | state |
| | 10 | Writing and reading possible only in the “open” or “secure” |
| | | state |
| | 11 | No writing possible, reading possible only in the “open” or |
| | | “secure” state |
| 10 | 00 | Writing possible only in the “secure” state, no restriction for |
| | | reading |
| | 01 | Writing and reading possible only in the “secure” state with a |
| | | password |
| | 10 | Writing possible only in the “secure” state with password1, |
| | | reading possible only in the “secure” state with password2 |
| | 11 | Still unassigned or reserved for later functions |
| 11 | 00 | No writing possible, reading possible without password |
| | 01 | No writing, reading with password1 |
| | 10 | No writing, reading with password2 |
| | 11 | No writing, no reading |

These settings, assigned to the different bit patterns of the master bits and sub-bits, are of course only one possibility for adapting the transponder to different requirements. Here, in the exemplary embodiment, the entire memory area is assigned a common access control.

In an embodiment, further fine setting of the access control by second sub-bits is possible. Thus, it is conceivable, for example, that the access control information comprising the following bit pattern “11 11” of the master bits MB “11” and the sub-bits SB “11” is overloaded. If additional second sub-bits are present, these are then utilized to perform a further setting or scaling.

In a second exemplary embodiment, one bit or a plurality of bits, particularly four bits, are provided as a second sub-access control information. In the exemplary embodiment, a setting, which affects the entire memory area of the transponder, can be made by the master bits and the first sub-bits. It is further possible by means of the second sub-bit or the second sub-bits to divide the memory area into any number of memory blocks, whereby the read and/or write access to the specific memory block can be set by the second sub-bit or the second sub-bits, particularly in the case of four sub-bits by a bit pattern with four bits according to FIG. 1.

FIG. 2 shows schematically a memory area 1 of a transponder, the transponder not being shown. The memory area 1 is divided into five memory blocks A to E. Each memory block A to E is assigned access control information a-e, which specifies access authorization to the memory block. The access control information a-e is stored in a shadow memory 2, which is divided into sub-memory areas a-e parallel or corresponding to memory blocks A-E.

In the depicted embodiment the access control information a to d comprises at least eight bits.

If the first master bits MB and the first sub-bits SB have the indicated bit pattern “1111,” it is then signaled that further information may follow. The next four bits then serve for the selective setting of access control in memory area A. If no further information follows, the bit pattern “1111” signals, for example, as described above, that neither writing nor reading is possible. The bit pattern is thereby overloaded and the memory is thereby individually configurable.

The next eight bits serve to set access authorization to a memory block B.

Access control information e is not followed by any other sub-bits, so that the access control information, for example, can also apply to memory blocks coming after memory block E, if such subsequent memory blocks are present.

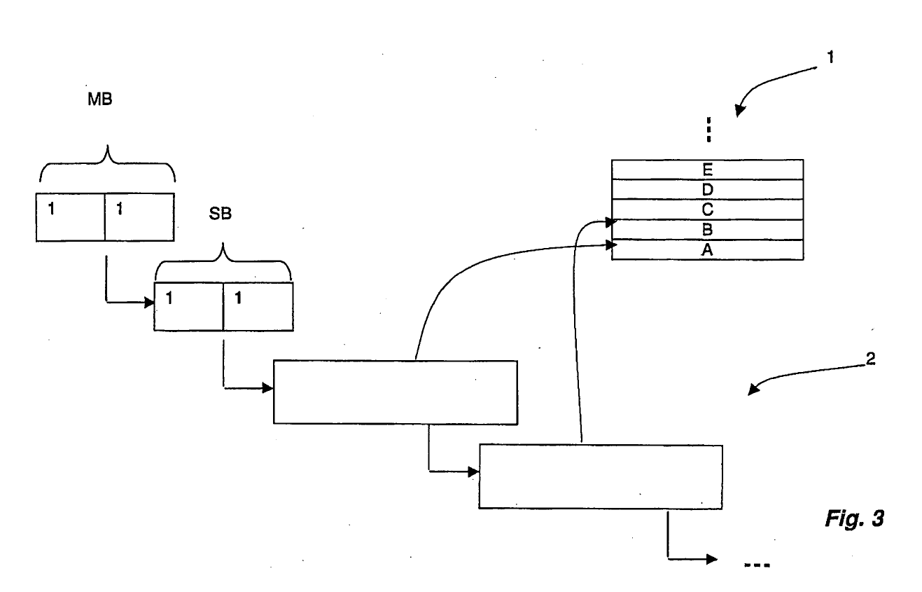

FIG. 3 shows schematically a dynamic subdivision of memory area 1 into memory blocks A-E and a subdivision of the shadow memory area 2 into parallel or corresponding sub-memory areas.

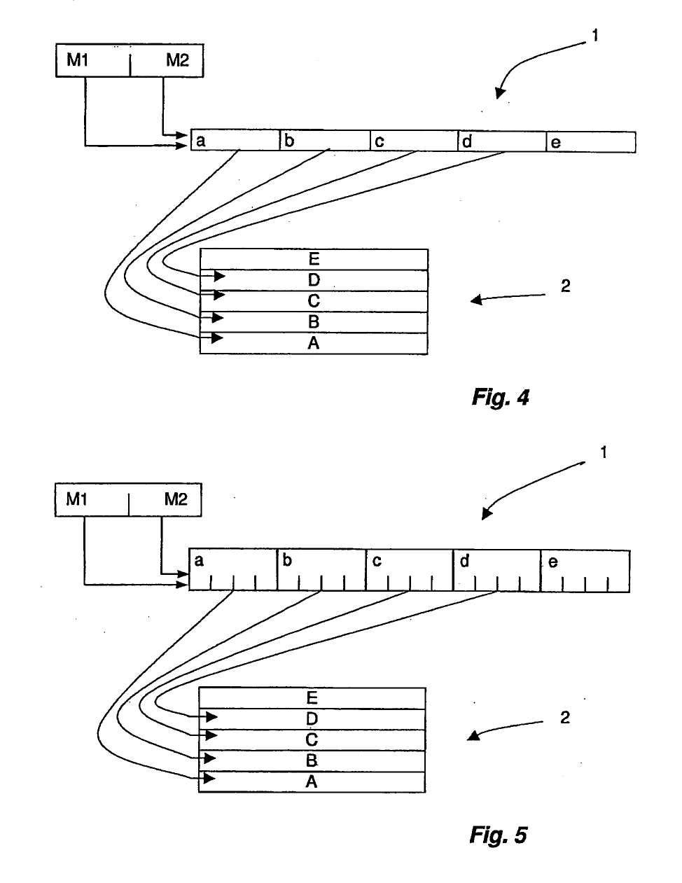

FIG. 4 shows another embodiment of the invention, whereby memory area 1 is also divided into any number of memory blocks A-E according to FIG. 2. Access to the entire memory area 1 or all memory blocks A-E is specified by two master bits M1, M2, which correspond to the lock bits known from the aforementioned draft standard (see, for example, ISO/IEC CD 18000-6C 6.3.2.10.3.5). A first master bit M1 or lock bit in this case specifies a write protection for the memory area, whereas a second master bit M2 or lock bit makes the set access authorization permanent. The second master bit M2 is therefore also called a permalock bit. In an embodiment corresponding to the draft standard, the master bits M1, M2 are assigned the following meaning here:
00: writing is possible in the “open” or “secure” state of the transponder;
01: writing is always possible in the “open” or “secure” state of the transponder; the memory area can never be write-protected (locked);
10: writing is possible only in the “secure” state of the transponder; and
11: writing to this memory area is not possible in any transponder state.

The aforementioned draft standard specifies that a permalock bit once it is set cannot be cleared again.

According to the invention, each memory block A-E is assigned further at least one sub-access control information a-e, comprising at least one sub-bit or block bit, whereby access to an associated memory block A-E can be blocked by the block bit contrary to general access control information M1, M2. The block sub-bit is subordinate to the master bits; i.e., when the master bits have the aforementioned configuration “01” according to which the entire memory area cannot be write protected, a set block sub-bit is ignored and/or a setting of the block sub-bit is prevented. The block sub-bit in an embodiment is designed to be one-time programmable, whereby a set state is not reversible. In an initial configuration of the transponder, for example, all sub-bits are not set. Individual memory blocks A-E can then be protected from writing (permanently) by setting of the specific sub-bits.

In another embodiment, more than one sub-bit per sub-access control information a-e is provided, for example, four sub-bits, as shown in FIG. 5. This makes possible an individual adjustment of each individual memory block A-E to further requirements. For example, write accesses to individual memory blocks A-E can be specified individually.

In again different embodiments, in each case, two or more memory blocks can be assigned a common sub-bit.

During use, a transponder or a tag is used, for example, in conjunction with a sensor to monitor, for example, chilled goods, whereby temperature profiles can be stored in the transponder in a memory area, provided for this, by the sensor. To prevent the temperature profiles from being falsified, for example, in order to fake adherence to legally stipulated quality standards, this memory area and/or a memory block or several memory blocks of the memory area are to be protected from overwriting by reader units from the outside, for example, via the so-called radio interface. At the same, it should be possible in the indicated example to release other memory blocks and/or other memory areas for writing for certain users, so that, for example, during a transfer of risk an authorized user can record this in the transponder using a time stamp. It is obvious that it is not desirable in this case that successive users in the logistics chain have write access to the same memory blocks. Otherwise a subsequent user could again correct at any time his time of the transfer of risk. The different users are each given, for example, a password, whereby with use of this password they are granted write access to a memory block allocated to them. Read access can also be blocked or released with conditions. Subdivision into several memory blocks with different access authorizations can thus reduce the risks for a carrier in the logistics chain.

In another exemplary embodiment, a transponder is configured with two identifiers ID1, ID2. The two password areas typically present in the transponder are then assigned to the two identifiers ID1, ID2. This results in the setting options shown in the following table:

| | | |
|---|---|---|
| 00 | 00 | No restriction during reading or writing |
| | 01 | Still unassigned or reserved for later functions |
| | 10 | Still unassigned or reserved for later functions |
| | 11 | Still unassigned or reserved for later functions |
| 01 | 00 | Writing and reading with ID1 possible only in the “open” or |
| | | “secure” state, with active ID2 no write and/or read |
| | | authorization |
| | 01 | Writing and reading with ID1 possible only in the “open” or |
| | | “secure” state, with active ID2 no write and/or read |
| | | authorization |
| | 10 | Writing and reading with ID2 possible only in the “secure” |
| | | state |
| | 11 | No writing possible, reading possible only in the “open” or |
| | | “secure” state with ID1, with active ID2 no write and/or read |
| | | authorization |
| 10 | 00 | Writing and reading possible with ID2 only in the “open” or |
| | | “secure” state, with active ID1 no write and/or read |
| | | authorization |
| | 01 | Writing and reading possible with ID2 only in the “open” or |
| | | “secure” state, with active ID1 no write and/or read |
| | | authorization |
| | 10 | Writing and reading with ID1 possible only in the “secure” |
| | | state |
| | 11 | No writing possible, reading possible only in the “open” or |
| | | “secure” state with ID2, with active ID1 no write and/or read |
| | | authorization |
| 11 | 00 | No writing possible, reading possible without password |
| | 01 | No writing, reading with ID1 |
| | 10 | No writing, reading with ID2 |
| | 11 | No writing, no reading |

In this case, the bit sequence “1111” is overloaded in an embodiment. If a second sub-access control information is present, then, for example, the bit sequence “1111” only determines that no writing is possible. A read authorization can be defined by a second sub-access control information.

In another exemplary embodiment, the memory area is allocated to the EPC. Here, a setting is carried out by the method of the invention in such a way that without sub-bits the write protection specified by the master bits, i.e., preferably the lock bits, applies only to a first identifier ID1. If, on the contrary, there is sub-access control information of the invention, then the following functions can be set depending on the sub-access control information of the invention: (1) The EPC is transmitted only with the use of a read command (“read” command according to draft standard; see, for example, ISO/IEC_CD 18000-6C 6.3.2.10.3.2); (2) the EPC is output encoded with the use of the read command; (3) the second identifier ID2 and/or any other information are output encoded after an acknowledge command; and/or (4) subsettings apply only to the additional identifiers.

The listed setting options are exemplary. It is apparent that other functions can be assigned to the individual access control information; in each case, a rough setting occurs by means of the master access control information and a fine setting by one or more subordinate sub-access control information.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for specifying access authorization to at least one memory area of a transponder, particularly a passive and/or backscatter-based transponder, the method comprising:
assigning the memory area access control information, the access control information comprising at least one configurable master access control information and write access to the memory area is released at least by a first configuration of the master access control information and write access to the memory area is blocked by a second configuration of the master access control information;
storing the access control information in the transponder;
assigning the master access control information least one first settable sub-access control information;
scaling the master access control information by the assignment of the first sub-access control information so that access authorization specified by the configuration of the master access control information is adapted to at least one additional requirement.

2. The method according to claim 1, wherein access authorization for read access to the memory area is specified by the first sub-access control information.

3. The method according to claim 1, wherein the first sub-access control information is overloaded at least in part, wherein a configuration of the sub-access control information is assigned at least two options for access control and wherein the access authorization is specified at least depending on the master access control information, the first sub-access control information, and a selection parameter.

4. The method according to claim 1, wherein the first sub-access control information comprises at least one sub-bit, preferably at least two sub-bits, by which four bit patterns are formed.

5. The method according to claim 1, wherein the first sub-access control information is scaled by at least one lower-ranking second sub-access control information.

6. The method according to claim 5, wherein the memory area is divided into at least two memory blocks, and wherein access authorization to the memory blocks is specified individually by the second sub-access control information.

7. A transponder, particularly passive and/or backscatter-based transponder, for an RFID system, comprising:
at least one transponder; and
at least one reader unit, with at least one memory area,
wherein the memory area is assigned access control information to specify access authorization to the memory area,
wherein the access control information comprises at least one configurable master access control information,
wherein write access to the memory area is released at least by a first configuration of the master access control information and write access to the memory area is blocked by a second configuration of the master access control information,
wherein the access control information comprises at least one first sub-access control information, and
wherein the master access control information is scaled by the first sub-access control information, so that access authorization specified by the configuration of the master access control information is adapted to at least one additional requirement.

8. A method for specifying access authorization to at least one memory area of a passive and/or backscatter-based transponder, the method comprising:
assigning the memory area access control information, the access control information comprising at least one configurable master access control information, the master access control information comprising two bits, write access to the memory area being released by a first configuration of a first bit of the master access control information, and write access to the memory area being blocked by a second configuration of the first bit of the master access control information, and permanence of the access control information is specified by the second bit of the master access control information;
storing the access control information in the transponder;
assigning the access control information at least one settable sub-access control information; and
dividing the memory area into at least two memory blocks, wherein access authorization to the memory blocks is specified individually by the sub-access control information.

9. The method according to claim 8, wherein the sub-access control information comprises at least one sub-bit, preferably at least two sub-bits, particularly four sub-bits, by which 16 bit patterns are formed.

10. The method according to claim 8, wherein access authorization for read access to the memory area is specified further by sub-access control information.

11. The method according to claim 8, wherein the sub-access control information specifies access authorization for read and/or write access to the memory area depending on at least one password.

12. The method according to claim 8, wherein the sub-access control information is overloaded at least in part, wherein a configuration of the sub-access control information is assigned at least two options for access control, and wherein the access authorization is specified at least depending on the master access control information, the sub-access control information, and a selection parameter.

13. The method according to claim 8, wherein the access control information is stored at least in part in a shadow memory area, the shadow memory area being divided into sub-memory areas parallel to the memory blocks.

14. The method according to claim 8, wherein the subdivision into memory blocks and/or into sub-memory areas is carried out dynamically during an initialization.

15. A transponder, particularly a passive and/or backscatter-based transponder, for an RFID system, comprising:
at least one transponder; and
at least one reader unit having at least one memory area, the memory area being assigned access control information to specify access authorization to the memory area, and the access control information comprising at least one configurable master access control information,
wherein the master access control information comprises two bits,
wherein write access to the memory area is released at least by a first configuration of a first bit of the master access control information and write access to the memory area is blocked by a second configuration of the first bit of the master access control information,
wherein permanence of the access control information is specified by the second bit of the master access control information,
wherein the access control information comprises at least one first sub-master access control information, and
wherein the memory area is divided into at least two memory blocks, access authorization to the memory blocks being specified individually by the sub-access control information.

16. An RFID system comprising at least one reader unit and at least one transponder according to claim 7.

17. The RFID system according to claim 16, wherein the first sub-access control information is overloaded at least in part, wherein access authorization is specified at least depending on the master access control information, the sub-access control information, and a selection parameter, and wherein at least one selection parameter is stored in a cross reference list.

18. The RFID system according to claim 16, wherein at least one configuration bit, which can be read out by the reader unit, is stored in the transponder, and wherein the configuration bit indicates at least one scaling effect, a scaling intensity, and/or a selection parameter.
